(19) United States
(12) Patent Application Publication
(10) Pub. No.: US 2010/0131927 A1
(43) Pub. Date: May 27, 2010

(54) AUTOMATED GUI TESTING

(75) Inventors: Srinivas S. Pinjala, Bangalore (IN); Jonathan S. Tilt, Romsey (GB)

Correspondence Address: FERENCE & ASSOCIATES LLC, 409 BROAD STREET, PITTSBURGH, PA, 15143, US

(73) Assignee: IBM Corporation, Armonk, NY (US)

(21) Appl. No.: 12/276,944

(22) Filed: Nov. 24, 2008

(51) Int. Cl. G06F 9/44

(52) U.S. Cl. 717/125

(57) ABSTRACT

Graphical User Interface (GUI) automation tools continue to evolve in their sophistication and complexity. However, it is still necessary to tailor such automation to the machine configuration that the test is being run on. This can be a costly and time consuming exercise when developing software for a myriad of different platforms. Broadly contemplated herein, in accordance with at least one embodiment of the invention, are arrangements and processes for recording a test solely on one machine while generating images on all the other available environments.

### BACKGROUND

Graphical User Interface (GUI) automation tools continue to evolve in their sophistication and complexity. However, it is still necessary to tailor such automation to the machine configuration that the test is being run on. This can be a costly and time consuming exercise when developing software for a myriad of different platforms.

Generally, most conventional GUI test automation tools work on a “record and playback” concept. Usually, user actions are recorded and the actions are repeated during playback. In this context, GUI automation tools normally have three different kinds of verification points: Data, Property and Image verification. Each verification point provides the opportunity to compare an actual value against an expected value.

Data verification is used to compare data, for example, text in a text field, while property verification is used to verify the property of an object, for example, the color of text. Finally, image verification is done as a supplement to visual verification. For example, image verification may be used to check if a password is appearing with asterisks in a text field, wherein merely a data or property verification could not cover this. Accordingly, for an image verification, instead of just affording an opportunity to do a manual visual check, the tool captures an image during recording and uses this image to compare with later images in subsequent runs.

Since it is rare for modern software to only run in one environment, GUI tests frequently need to execute in different environments, e.g., combinations of hardware, operating systems and software stacks. However, a major problem arises in that image verifications are normally not able to cope with the inevitability that, on different platforms, objects will be rendered differently. For instance, resolutions and graphics drivers on different machines will likely differ tremendously such that an image obtained on one machine might be different on another machine (e.g., a text field on WINDOWS XP might appear differently on WINDOWS VISTA and RED HAT LINUX, etc.) This means that recording needs to take place with each and every test environment, which can be tremendously time-consuming, inefficient and costly.

### SUMMARY

Broadly contemplated herein, in accordance with at least one embodiment of the invention, are arrangements and processes for recording a test solely on one machine while generating images on all the other available environments.

In summary, this disclosure describes a method including recording an image for a graphical user interface at a single recording location, and verifying the recorded image with respect to a first test execution environment and with respect to a second test execution environment, the verifying comprising returning to the single recording location a displayed image from the first test execution environment and a displayed image from the second test execution environment, the verifying further comprising comparing the displayed images from the first test execution environment and the second text execution environment.

Also, this disclosure describes an apparatus comprising: a main memory; in communication with the main memory, a single recording location for recording an image for a graphical user interface; and a verifier which verifies the recorded image with I 0 respect to a first test execution environment and with respect to a second test execution environment; the verifier acting to return to the single recording location a displayed image from the first test execution environment and a displayed image from the second test execution environment; the verifier further acting to compare the displayed images from the first test execution environment and the second text execution environment.

Furthermore, this disclosure additionally describes a program storage device readable by machine, tangibly embodying a program of instructions executable by the machine to perform a method including recording an image for a graphical user interface at a single recording location, and verifying the recorded image with respect to a first test execution environment and with respect to a second test execution environment, the verifying comprising returning to the single recording location a displayed image from the first test execution environment and a displayed image from the second test execution environment, the verifying further comprising comparing the displayed images from the first test execution environment and the second text execution environment.

### BRIEF DESCRIPTION OF THE DRAWINGS

FIG. 1 schematically illustrates a computer system.

FIG. 2 schematically illustrates a plug-in that may be employed with different testing environments.

FIG. 3 provides code for a plug-in such as that illustrated in FIG. 2.

### DETAILED DESCRIPTION

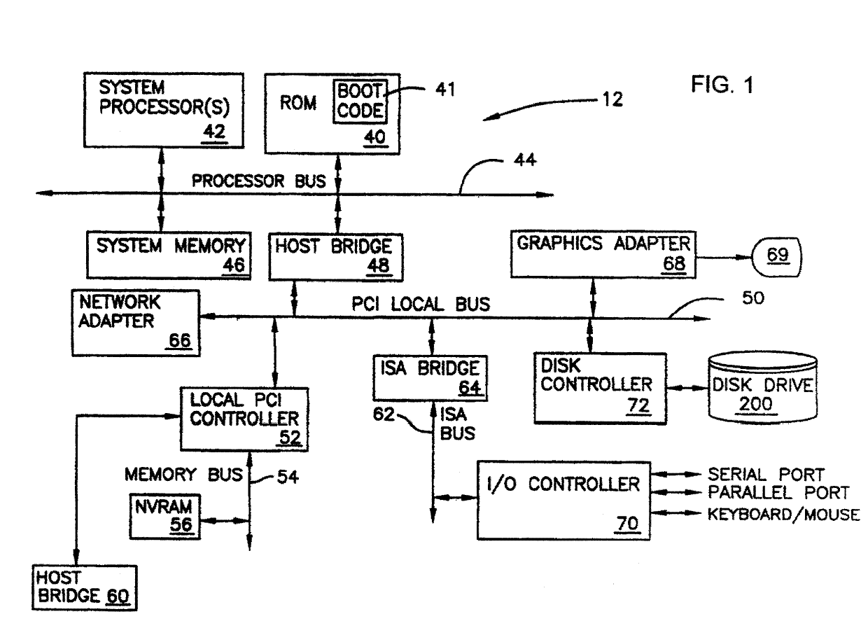

It will be readily understood that the embodiments of the invention, as generally described and illustrated in the Figures herein, may be arranged and designed in a wide variety of different configurations. Thus, the following more detailed description of the embodiments of the apparatus, system, and method of the embodiments of the invention, as represented in FIGS. 1-3, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that embodiment of the invention can be practiced without one or more of the specific details, or with other methods, components, materials, etc. In other instances, well-known structures, materials, or operations are not shown or described in detail to avoid obscuring aspects of embodiments of the invention.

The illustrated embodiments of the invention will be best understood by reference to the drawings, wherein like parts are designated by like numerals or other labels throughout. The following description is intended only by way of example, and simply illustrates certain selected embodiments of devices, systems, and processes.

Referring now to FIG. 1, there is depicted a block diagram of an embodiment of a computer system 12. The embodiment depicted in FIG. 1 may be a notebook computer system, such as one of the ThinkPad® series of personal computers previously sold by the International Business Machines Corporation of Armonk, N.Y., and now sold by Lenovo (US) Inc. of Morrisville, N.C.; however, as will become apparent from the following description, the embodiments of the invention may be applicable to any data processing system. Notebook computers, as may be generally referred to or understood herein, may also alternatively be referred to as “notebooks”, “laptops”, “laptop computers” or “mobile computers”.

As shown in FIG. 1, computer system 12 includes at least one system processor 42, which is coupled to a Read-Only Memory (ROM) 40 and a system memory 46 by a processor bus 44. System processor 42, which may comprise one of the AMD™ line of processors produced by AMD Corporation or a processor produced by Intel Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 12 to a local area network (LAN), and graphics adapter 68, which interfaces computer system 12 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 12 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard and mouse. In addition, I/O controller 70 supports external communication by computer system 12 via serial and parallel ports, including communication over a wide area network (WAN) such as the Internet. A disk controller 72 is in communication with a disk drive 200 for accessing external memory. Of course, it should be appreciated that the system 12 may be built with different chip sets and a different bus structure, as well as with any other suitable substitute components, while providing comparable or analogous functions to those discussed above.

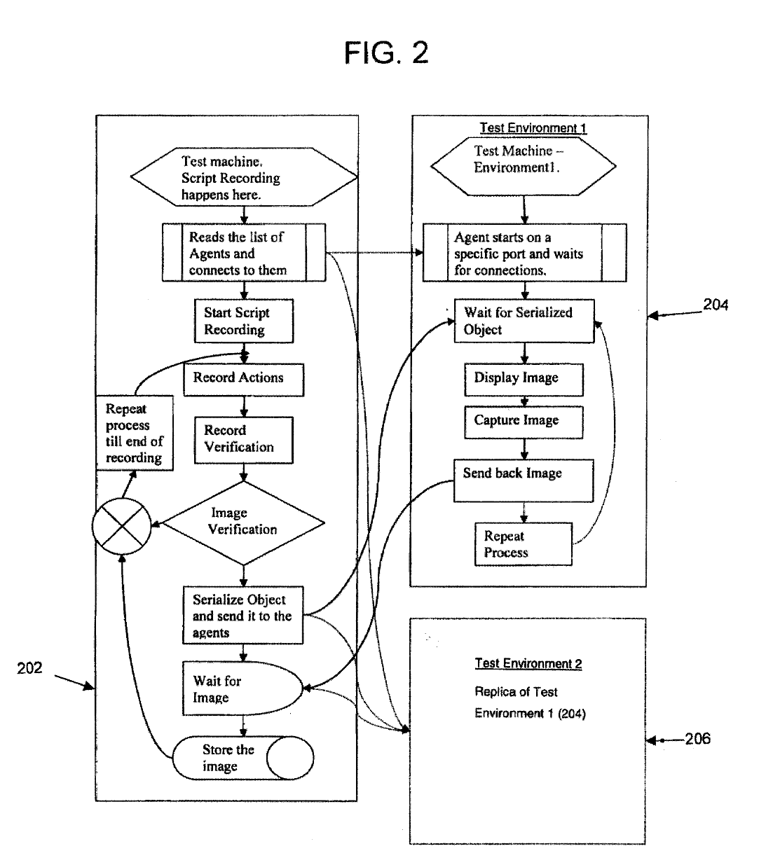

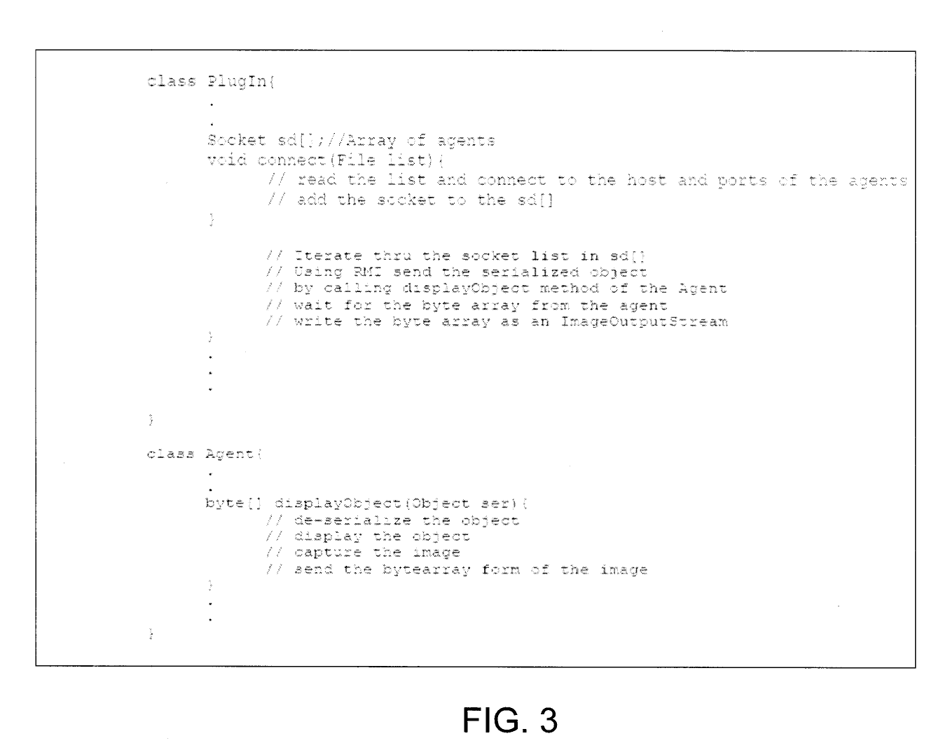

Reference may now be made herethroughout to FIGS. 2 and 3 by way of appreciating and understanding embodiments of the invention. It should be understood that the processes broadly contemplated in accordance with FIGS. 2 and 3 can be applied to a very wide range of computer systems, including that indicated at 12 in FIG. 1.

As mentioned above, there are broadly contemplated herein, in accordance with at least one embodiment of the invention, arrangements and processes for recording a test solely on one machine while generating images on all the other available environments. A machine, as such, could correspond to a computer system such as that indicated at 12 in FIG. 1 (whereby embodiments of the invention could be carried out in the context of graphics adapter 68 and display 69), or to any of a very wide variety of other computer systems.

In accordance with at least one embodiment of the invention, a pool of test execution environments can be created, and then an agent application can be run on each environment in this pool. Next, the test may be recorded on one machine (which may be referred to as a primary server). Whenever an image is recorded, the object can be serialized, and this serialized object can be sent to each of the agents. The agent may now display the serialized object in the new environment and return the image of the displayed object to the primary server. An advantage of this approach is that it dramatically reduces the time and effort required to generate the test artifacts used in verifying a large amount of machine configurations.

A plug-in can be added to the GUI Test automation tool; an example of a suitable plug-in is indicated at 202 in FIG. 2. Whenever the record option is exercised, the plug-in 202 can be invoked, and, as shown, the list of agents is then read. The list may contain a hostname and port corresponding to different Test Execution Environments on which Agents are running (e.g., Test Execution Environments 1 and 2 indicated at 204 and 206, respectively, where Test Environment 2 is a replica of Test Environment 1). The plug-in 202 connects to the agents. W hen any image verification is exercised on an object, the object is serialized (where the state of the object can be stored.) The serialized object can then be sent (using a mechanism such as socket programming) from the primary server to the agents. Each agent then can take the serialized object, de-serialize it and display it. The resultant image of the object can then be sent back to the plug-in 202, and can be stored in a central location with a standardized naming convention. For example, the name of the image can contain name of the image, hostname of the machine where the image was generated, its resolution, etc.

During playback the image name, hostname resolution can be obtained form the central storage location at runtime and the appropriate image can be loaded for comparison against the actual image. Using this approach, it is thus possible to use just one record step to store multiple images from different environments.

In a possible implementation using Java, the plug-in can have the API (application programming interface) shown in FIG. 3, though it of course should be understood that this is merely an illustrative and non-restrictive example.

It is to be understood that the invention, in accordance with at least one embodiment, includes elements that may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

Generally, embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Generally, although illustrative embodiments of the present invention have been described herein with reference to the accompanying drawings, it is to be understood that the invention is not limited to those precise embodiments.

What is claimed is:

1. A method comprising:
recording an image for a graphical user interface at a single recording location; and
verifying the recorded image with respect to a first test execution environment and with respect to a second test execution environment;
said verifying comprising returning to the single recording location a displayed image from the first test execution environment and a displayed image from the second test execution environment;
said verifying further comprising comparing the displayed images from the first test execution environment and the second text execution environment.

2. The method according to claim 1, wherein the single recording location comprises a primary server.

3. The method according to claim 1, wherein the displayed image from the first test execution environment comprises the recorded image as rendered at the first text execution environment and the displayed image from the second text execution environment comprises the recorded image as rendered at the second test execution environment.

4. The method according to claim 1, wherein said recording comprises serializing the recorded image.

5. The method according to claim 4, wherein said verifying comprises sending the serialized recorded image to the first test execution environment and the second test execution environment.

6. The method according to claim 5, wherein said verifying further comprises returning an image corresponding to the serialized recorded image to the single recording location.

7. The method according to claim 5, wherein the single recording location comprises a plug-in.

8. An apparatus comprising:
a main memory;
in communication with said main memory, a single recording location for recording an image for a graphical user interface; and
a verifier which verifies the recorded image with respect to a first test execution environment and with respect to a second test execution environment;
said verifier acting to return to the single recording location a displayed image from the first test execution environment and a displayed image from the second test execution environment;
said verifier further acting to compare the displayed images from the first test execution environment and the second text execution environment.

9. The apparatus according to claim 8, wherein said single recording location comprises a primary server.

10. The apparatus according to claim 8, wherein the displayed image from the first test execution environment comprises the recorded image as rendered at the first text execution environment and the displayed image from the second text execution environment comprises the recorded image as rendered at the second test execution environment.

11. The apparatus according to claim 8, wherein said single recording location acts to serialize the recorded image.

12. The apparatus according to claim 11, wherein said verifier acts to send the serialized recorded image to the first test execution environment and the second test execution environment.

13. The apparatus according to claim 12, wherein said verifier further acts to return an image corresponding to the serialized recorded image to said single recording location.

14. The apparatus according to claim 12, wherein said single recording location comprises a plug-in.

15. A program storage device readable by machine, tangibly embodying a program of instructions executable by the machine to perform a method comprising:
recording an image for a graphical user interface at a single recording location; and
verifying the recorded image with respect to a first test execution environment and with respect to a second test execution environment;
said verifying comprising returning to the single recording location a displayed image from the first test execution environment and a displayed image from the second test execution environment;
said verifying further comprising comparing the displayed images from the first test execution environment and the second text execution environment.

16. The program storage device according to claim 15, wherein the single recording location comprises a primary server.

17. The program storage device according to claim 15, wherein the displayed image from the first test execution environment comprises the recorded image as rendered at the first text execution environment and the displayed image from the second text execution environment comprises the recorded image as rendered at the second test execution environment.

18. The program storage device according to claim 15, wherein said recording comprises serializing the recorded image.

19. The program storage device according to claim 18, wherein said verifying comprises sending the serialized recorded image to the first test execution environment and the second test execution environment.

20. The program storage device according to claim 19, wherein said verifying further comprises returning an image corresponding to the serialized recorded image to the single recording location.
